(19) United States
(12) Patent Application Publication
(10) Pub. No.: US 2004/0096717 A1
(43) Pub. Date: May 20, 2004

(54) Solid polymer type fuel cell

(76) Inventors: Yoichi Asano, Saitama (JP); Masaaki Nanaumi, Saitama (JP); Hiroshi Sohma, Saitama (JP); Nagayuki Kanaoka, Saitama (JP); Nobuhiro Saito, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/473,395

(22) PCT Filed: Mar. 28, 2002
(86) PCT No.: PCT/JP02/03042

(30) Foreign Application Priority Data
Mar. 30, 2001 (JP) 2001-97800

(51) Int. Cl. H01M 8/10

(52) U.S. Cl. 429/30; 429/33

(57) ABSTRACT

The present invention provides a polymer electrolyte fuel cell, which comprises: a pair of electrodes 2 and 3 both having a catalyst layer 5, where catalyst particles consisting of a catalyst carrier and a catalyst supported by the carrier are integrated by an ion-conductive polymer binder; and a polymer electrolyte membrane 1 sandwiched between the electrodes 2 and 3 on their sides having the catalyst layer 5. The polymer electrolyte fuel cell comprises: the polymer electrolyte membrane 1 having a coefficient of dynamic viscoelasticity at 110° C. in a range of 1×10⁹ to 1×10¹¹ Pa; and the catalyst layer 5 made of the ion-conductive polymer binder having a coefficient of dynamic viscoelasticity at 110° C. smaller than the polymer electrolyte membrane 1. The polymer electrolyte fuel cell further comprises a buffer layer 6, comprising an ion-conductive material having a coefficient of dynamic viscoelasticity at 110° C. smaller than the polymer electrolyte membrane 1 but is greater than that of the ion-conductive polymer binder of the catalyst layer 5, and provided between the polymer electrolyte membrane 1 and the catalyst layer 5 of each of the electrodes 2 and 3.

### TECHNICAL FIELD

The present invention relates to a polymer electrolyte fuel cell comprising a polymer electrolyte membrane.

### BACKGROUND ART

The petroleum source has been exhausted, and at the same time, environmental problems such as global warming from consumption of fossil fuel have increasingly become serious. Thus, a fuel cell receives attention as a clean power source for electric motors that is not accompanied with the generation of carbon dioxide. The fuel cell has been widely developed, and some fuel cells have become commercially practical. When the fuel cell is mounted in vehicles and the like, a polymer electrolyte fuel cell comprising a polymer electrolyte membrane is preferably used because it easily provides a high voltage and a large electric current.

The polymer electrolyte fuel cell comprises a pair of electrodes consisting of a fuel electrode and an oxygen electrode, and a polymer electrolyte membrane capable of conducting ions, which is located between the electrodes. Each of the fuel and oxygen electrodes has a backing layer and a catalyst layer, and each of the electrodes is in contact with the polymer electrolyte membrane through the catalyst layer. The catalyst layer comprises catalyst particles consisting of a catalyst carrier and a catalyst such as Pt supported by the carrier, which are integrated by an ion-conductive polymer binder.

When reducing gas such as hydrogen or methanol is introduced into the fuel electrode of the polymer electrolyte fuel cell, the reducing gas reaches the catalyst layer through the backing layer, and protons are generated by the action of the catalyst. The protons transfer from the catalyst layer to the catalyst layer of the oxygen electrode through the polymer electrolyte membrane.

When oxidizing gas such as air or oxygen is introduced into the oxygen electrode while introducing the reducing gas into the fuel electrode, the protons are reacted with the oxidizing gas by the action of the catalyst in the catalyst layer on the side of the oxygen electrode, so as to generate water. Thus, electric current is obtained by connecting the fuel electrode with oxygen electrode by a conductor.

Previously, in the polymer electrolyte fuel cells, a perfluoroalkylene sulfonic acid polymer (e.g., Nafion (product name) manufactured by DuPont) has been widely used for the polymer electrolyte membrane and the ion-conductive polymer binder in the catalyst layer. The perfluoroalkylene sulfonic acid polymer is sulfonated, and accordingly it has an excellent proton conductivity. Moreover, the compound also has a chemical resistance as a fluorocarbon resin. However, the compound has a problem in that it is extremely expensive.

Thus, in recent years, a low-priced polymer electrolyte membrane that does not contain fluorine in its molecular structure or contains a reduced amount of fluorine has been proposed. For example, U.S. Pat. No. 5,403,675 discloses a polymer electrolyte membrane comprising sulfonated rigid-rod polyohenylene. The sulfonated rigid-rod polyohenylene described in the specification is obtained by reacting a polymer obtained by polymerizing an aromatic compound having a phenylene chain with a sulfonating agent, so as to introduce a sulfonic acid group into the polymer.

However, the sulfonated rigid polyhenylene is inconvenient in that it has a greater coefficient of dynamic viscoelasticity as an index of hardness than the perfluoroalkylene sulfonic acid polymer compound, and that it is therefore harder. Accordingly, when a polymer electrolyte membrane comprising the sulfonated rigid polyhenylene is used as an ion-conductive polymer binder and is to be laminated with a catalyst layer comprising the perfluoroalkylene sulfonic acid polymer, a sufficient adhesiveness can hardly be obtained between the polymer electrolyte membrane and each of the fuel and oxygen electrodes. Thus, protons passing through the interface between the polymer electrolyte membrane and the catalyst layer are inhibited, thereby increasing resistance overvoltage.

### DISCLOSURE OF THE INVENTION

It is an object of the present invention to solve the problems and to provide a polymer electrolyte fuel cell, which is capable of obtaining a good adhesiveness between a polymer electrolyte membrane having a greater coefficient of dynamic viscoelasticity and electrodes both having a catalyst layer which is made of an ion-conductive polymer binder having a smaller coefficient of dynamic viscoelasticity. It is another object of the present invention to provide an inexpensive polymer electrolyte fuel cell capable of suppressing the increase of resistance voltage.

To achieve the objects, the polymer electrolyte fuel cell of the present invention comprises a pair of electrodes both comprising a catalyst layer, where catalyst particles consisting of a catalyst carrier and a catalyst supported by the catalyst carrier are integrated by an ion-conductive polymer binder, and a polymer electrolyte membrane sandwiched between the electrodes on their sides having the catalyst layer; the polymer electrolyte fuel cell being characterized in that the polymer electrolyte membrane has a coefficient of dynamic viscoelasticity at 110° C. in a range of 1×10⁹ to 1×10¹¹ Pa, and the ion-conductive polymer binder forming the catalyst layer has a coefficient of dynamic viscoelasticity at 110° C. smaller than that of the polymer electrolyte membrane, and that an additional buffer layer comprising an ion-conductive polymer material having a coefficient of dynamic viscoelasticity at 110° C. smaller than that of the polymer electrolyte membrane but greater than that of the ion-conductive polymer binder of the catalyst layer is provided between the polymer electrolyte membrane and the catalyst layer of at least either one of the electrodes.

Since the buffer layer has a coefficient of dynamic viscoelasticity at 110° C. that is intermediate between those of the polymer electrolyte membrane and of the catalyst layer made of the ion-conductive polymer binder, it can be closely in contact with both the polymer electrolyte membrane and the catalyst layer. Accordingly, the polymer electrolyte fuel cell of the present invention can reduce resistance overvoltage generated at the interface between the polymer electrolyte membrane and the catalyst layer.

The present invention is useful, when an ion-conductive material used as the polymer electrolyte membrane has a coefficient of dynamic viscoelasticity at 110° C. greater by approximately two orders of magnitude than an ion-conductive polymer binder forming the catalyst layer in a film state. Thus, in the polymer electrolyte fuel cell of the present invention, a perfluoroalkylene sulfonic acid polymer is used for the ion-conductive polymer binder. When the perfluoroalkylene sulfonic acid polymer is converted into a film, it has a coefficient of dynamic viscoelasticity at 110° C. of approximately 6.5×10⁷ Pa.

On the other hand, an ion-conductive material having a coefficient of dynamic viscoelasticity at 110° C. in a range of 1×10⁹ to 1×10¹¹ Pa is used for the polymer electrolyte membrane. An example of the ion-conductive material used for the polymer electrolyte membrane includes a sulfonated polyarylene which is a copolymer consisting of 30 to 95 mol % of an aromatic compound unit represented by the following formula (1) and 70 to 5 mol % of an aromatic compound unit represented by the following formula (2) and having sidechain sulfonic acid groups:

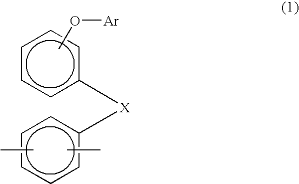

wherein Ar represents an aryl group, and X represents one type of divalent electron-attracting group selected from a group consisting of —CO—, —CONH—, —(CF₂)ₚ— (wherein p is an integer of 1 to 10), —C(CF₃)—, —COO—, —SO— and —SO₂—; and

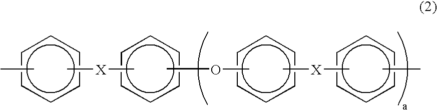

wherein X has the same meaning as that in formula (1), each of X may be identical or different, and a is an integer of 0 to 3.

The sulfonic acid group is not introduced into an aromatic ring next to the electron-attracting group, but it is only introduced into an aromatic ring that is not next thereto. Accordingly, in the sulfonated polyarylene, the sulfonic acid group is introduced into only an aromatic ring represented by Ar in the aromatic compound unit represented by the formula (1).

Thus, by altering the molar ratio between the aromatic compound unit represented by formula (1) and the aromatic compound unit represented by formula (2), the amount of the introduced sulfonic acid group, that is, an ion exchange capacity, can be changed.

It should be noted that sulfonic acid groups are not necessarily introduced into all the aromatic rings of the aromatic compound unit represented by the formula (1). It may also be possible that sulfonic acid groups are not introduced into some of the aromatic rings represented by the formula (1) by altering sulfonating conditions.

In the sulfonated polyarylene, if the aromatic compound unit represented by the formula (1) is less than 30 mol % and the aromatic compound unit represented by formula (2) exceeds 70 mol %, an ion exchange capacity necessary for the polymer electrolyte membrane cannot be obtained. In contrast, if the aromatic compound unit represented by formula (1) exceeds 95 mol % and the aromatic compound unit represented by formula (2) is less than 5 mol %, the amount of the introduced sulfonic acid groups is excessive, and the molecular structure thereby weakens.

The sulfonated polyarylene contains no fluorine in its molecular structure, or contains fluorine only as an electron-attracting group as described above. Accordingly, it is low-priced and can reduce the cost of the polymer electrolyte fuel cell.

A copolymer represented by the following formula (3) is an example of the sulfonated polyarylene:

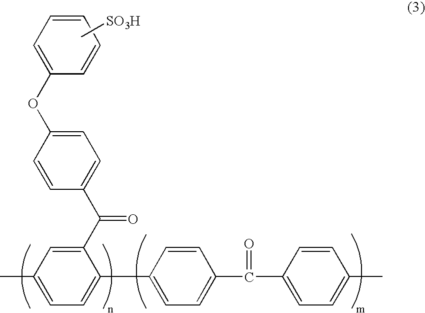

Moreover, a sulfonated polyether ether ketone polymer may also be used instead of the sulfonated polyarylene.

An example of the ion-conductive material constituting the buffer layer includes a sulfonated polyarylene that is a copolymer consisting of 50 to 70 mol % of the aromatic compound unit represented by the formula (1) and 50 to 30 mol % of the aromatic compound unit represented by the formula (2) and having side-chain sulfonic acid groups.

In the sulfonated polyarylene, if the aromatic compound unit represented by the formula (1) is less than 30 mol % and the aromatic compound unit represented by formula (2) exceeds 70 mol %, an ion exchange capacity required of the ion-conductive material might not be obtained. In contrast, if the aromatic compound unit represented by formula (1) exceeds 95 mol % and the aromatic compound unit represented by formula (2) is less than 5 mol %, the amount of the introduced sulfonic acid group increases as is described above, thereby weakening the molecular structure.

A copolymer represented by the following formula (4) can be used as an example of the sulfonated polyarylene:

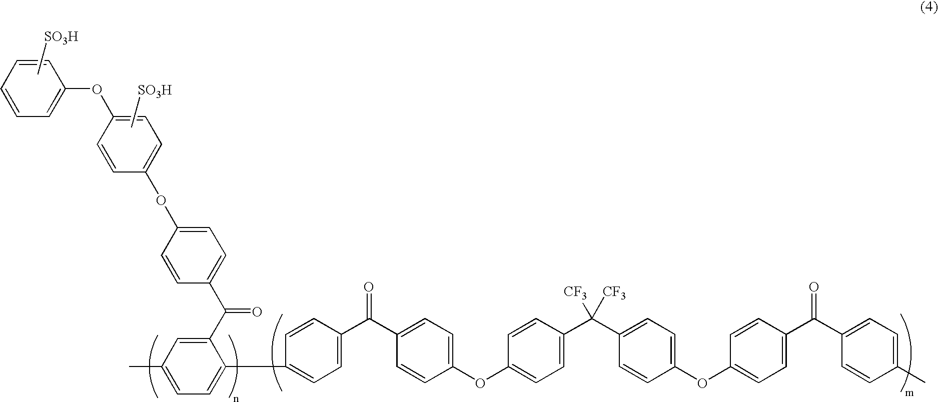

Examples of the ion-conductive material constituting the buffer layer may include either a sulfonated polyether ether ketone polymer represented by the following formula (5) or a perfluoroalkylene sulfonic acid polymer:

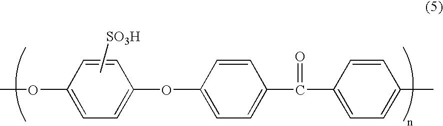

In order to obtain a good adhesiveness of the buffer layer to the catalyst layer, the ion-conductive material constituting the buffer layer preferably has a coefficient of dynamic viscoelasticity at 110° C. within a range from ½ to 1/1000 of that of the polymer electrolyte membrane.

### BRIEF DESCRIPTION OF THE DRAWINGS

FIG. 1 is an illustrative sectional view of the polymer electrolyte fuel cell of the present embodiment;

FIG. 2 is an illustrative view of an apparatus for measuring Q value of the polymer electrolyte fuel cell shown in FIG. 1;

FIG. 3 is a graph showing a measurement example of Q value by the apparatus of FIG. 2; and

FIG. 4 is a graph showing the relationship between the ratio of the coefficient of dynamic viscoelasticity at 110° C. of a polymer electrolyte membrane to that of a buffer layer, and Q value.

### BEST MODE FOR CARRYING OUT THE INVENTION

Next, the embodiment of the present invention will be explained further in detail below, with reference to the attached drawings.

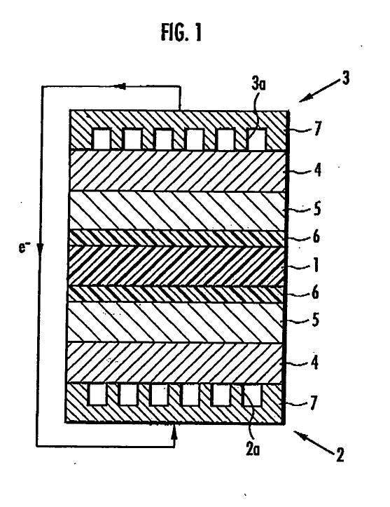

As shown in FIG. 1, the polymer electrolyte fuel cell of the present embodiment comprises a polymer electrolyte membrane 1 sandwiched between an oxygen electrode 2 and a fuel electrode 3. Each of the oxygen electrode 2 and the fuel electrode 3 comprises a backing layer 4 and a catalyst layer 5 formed on the backing layer 4, and it further comprises a buffer layer 6 between the catalyst layer 5 and the polymer electrolyte membrane 3.

Each backing layer 4 comprises a separator 7, which is adhered to an exterior side thereof. In the oxygen electrode 2, the separator 7 comprises an oxygen passage 2a, through which oxygen-containing gas such as air flows, on the backing layer 4 side. In the fuel electrode 3, the separator 7 comprises a fuel passage 3a, through which fuel gas such as hydrogen flows, on the backing layer 4 side.

In the polymer electrolyte fuel cell, as the polymer electrolyte membrane 1 there is used a sulfonated polyarylene obtained by reacting a polyarylene polymer consisting of 30 to 95 mol % of an aromatic compound unit represented by the following formula (1) and 70 to 5 mol % of an aromatic compound unit represented by the following formula (2) with concentrated sulfuric acid for sulfonation, so that a sulfonic acid group is introduced in a side chain thereof. The sulfonated polyarylene has a coefficient of dynamic viscoelasticity at 110° C. in a range of 1×10⁹ to 1×10¹¹ Pa:

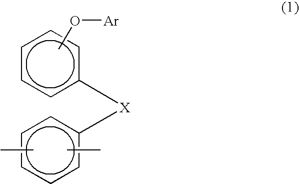

wherein Ar represents an aryl group, and X represents one type of divalent electron-attracting group selected from a group consisting of —CO—, —CONH—, —(CF₂)ₚ— (wherein p is an integer of 1 to 10), —C(CF₃)—, —COO—, —SO— and —SO₂—; and

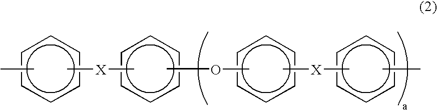

wherein X has the same meaning as that in formula (1), each of X may be identical or different, and a is an integer of 0 to 3.

An example of a monomer corresponding to the formula (1) includes 2,5-dichloro-4′-phenoxybenzophenone. Examples of a monomer corresponding to the formula (2) include 4,4′-dichlorobenzophenone and 4,4′-bis(4-chlorobenzoyl)diphenyl ether.

The polymer electrolyte membrane 1 is a dry film having a desired thickness, which is produced by dissolving the sulfonated polyarylene in a solvent such as N-methylpyrrolidone, and then performing the cast method on the thus obtained product.

In the polymer electrolyte fuel cell, the backing layer 4 of each of the oxygen electrode 2 and the fuel electrode 3 consists of a carbon paper and a substrate layer. The substrate layer is formed by, for example, mixing carbon black and polytetrafluoroethylene (PTFE) at a certain weight ratio, uniformly dispersing the obtained mixture in an organic solvent such as ethylene glycol so as to obtain a slurry, and applying the slurry on the one side of the carbon paper followed by drying.

Moreover, the catalyst layer 5 comprises catalyst particles consisting of, for example, a catalyst such as platinum supported by catalyst support such as carbon black (furnace black) at a certain weight ratio. The catalyst particles are mixed uniformly at a certain weight ratio with an ion-conductive polymer binder obtained by dissolving a perfluoroalkylene sulfonic acid polymer or the like in a solvent such as isopropanol or n-propanol, so as to prepare a catalyst paste. The catalyst layer 5 is produced by screen printing the catalyst paste on a substrate layer so that a certain amount of platinum is kept thereon, and then drying it.

The drying is carried out, for example, by drying at 60° C. for 10 minutes and then vacuum drying at 120° C. The perfluoroalkylene sulfonic acid polymer has a coefficient of dynamic viscoelasticity at 110° C. of approximately 6.5×10⁷ Pa.

Moreover, the buffer layer 6 is made of a sulfonated polyarylene, which is obtained by reacting a polyarylene polymer consisting of 50 to 70 mol % of the aromatic compound unit represented by the formula (1) and 50 to 30 mol % of the aromatic compound unit represented by the formula (2) with concentrated sulfuric acid for sulfonation, so that a sulfonic acid group is introduced in a side chain thereof. The sulfonated polyarylene has a coefficient of dynamic viscoelasticity at 110° C. in a range of approximately 1.6×10¹⁰ to 1.5×10¹⁰ Pa, which is intermediate between those of the polymer electrolyte membrane 1 and the ion-conductive polymer binder contained in the catalyst layer 5.

The sulfonated polyarylene is dissolved in a solvent such as N-methylpyrrolidone, and the obtained product is then casted on the catalyst layer 5 of each of the oxygen electrode 2 and the fuel electrode 3, so that the buffer layer 6 having a desired dry film thickness can be obtained.

Thereafter, the polymer electrolyte membrane 1 sandwiched between the buffer layers 6, 6 of the oxygen electrode 2 and the fuel electrode 3 is subjected to hot pressing, so as to form the polymer electrolyte fuel cell. The hot pressing can be carried out by, for example, performing the first pressing at 80° C. at 5 MPa for 2 minutes and then the second pressing at 160° C. at 4 MPa for 1 minute.

Next, the present invention will be described further in detail in the following examples and comparative examples.

### EXAMPLE 1

In the present example, a sulfonated polyarylene represented by the following formula (3) was first dissolved in N-methylpyrrolidone, and thereafter, a polymer electrolyte membrane 1 having a dry film thickness of 50 μm and an ion exchange capacity of 2.3 meq/g was prepared by the cast method.

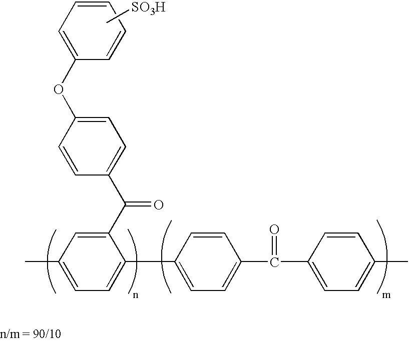

Thereafter, carbon black was mixed with polytetrafluoroethylene (PTFE) at a weight ratio of carbon black:PTFE=4:6, and the mixture was uniformly dispersed in ethylene glycol, so as to obtain a slurry. Next, the obtained slurry was applied on the one side of a carbon paper followed by drying, so as to obtain a substrate layer. Thus, a backing layer 4 consisting of the carbon paper and the substrate layer was produced.

Thereafter, catalyst particles consisting of platinum supported by furnace black at a weight ratio of furnace black:platinum=1:1, were uniformly mixed with an ion-conductive polymer binder at a weight ratio of catalyst particles:binder=8:5, so as to prepare a catalyst paste. The ion-conductive polymer binder was obtained by dissolving a perfluoroalkylene sulfonic acid polymer (Nafion (product name) by DuPont) in isopropanol/n-propanol. Thereafter, the catalyst paste was screen printed on the substrate layer, so that 0.5 mg/cm² platinum was kept thereon. Then, drying was carried out to form a catalyst layer 5. The drying of the catalyst paste was carried out by drying at 60° C. for 10 minutes and then vacuum drying at 120° C.

Thereafter, a sulfonated polyether ether ketone polymer represented by the following formula (5) was dissolved in N-methylpyrrolidone, and the dissolved product was then casted on the catalyst layer 5 of each of the oxygen electrode 2 and the fuel electrode 3, so as to form a buffer layer 6 having a dry film thickness of 5 μm and an ion exchange capacity of 1.5 meq/g.

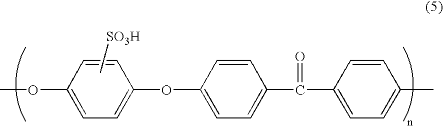

Thereafter, the polymer electrolyte membrane 1 sandwiched between the buffer layers 6 of the oxygen electrode 2 and the fuel electrode 3 was subjected to hot pressing, so as to form a polymer electrolyte fuel cell shown in FIG. 1. The hot pressing was carried out by performing the first pressing at 80° C. at 5 MPa for 2 minutes and then the second pressing at 160° C. at 4 MPa for 1 minute.

The coefficient of dynamic viscoelasticitys of the polymer electrolyte membrane 1 and the buffer layer 6 were measured in the tensile mode by a viscoelastic analyzer-RSAII (product name; Rheometric Science, Inc). Coefficient of dynamic viscoelasticity was defined as a value measured at 110° C. under the conditions of a frequency of 10 Hz (62.8 rad/second), a distortion of 0.05%, in a nitrogen current, and within a temperature range between room temperature and 350° C. As a result, in the present example, the coefficient of dynamic viscoelasticity at 110° C. of the polymer electrolyte membrane 1 was 4×10¹⁰ Pa, and the coefficient of dynamic viscoelasticity at 110° C. of the buffer layer 6 was 1.5×10⁹ Pa.

As described above, the perfluoroalkylene sulfonic acid polymer used for the ion-conductive polymer binder in the catalyst layer 5 had a coefficient of dynamic viscoelasticity of approximately 6.5×10⁷ Pa.

Subsequently, the electric potential generated by the polymer electrolyte fuel cell of the present example, and Q value as an index of the adhesiveness of the polymer electrolyte membrane 1 to the oxygen electrode 2 and the fuel electrode 3 were measured.

The electric potential was measured as follows: When current density was 0.2 A/cm², cell potential was measured under the power generation conditions of a pressure of 100 kPa both in the oxygen electrode 2 and the fuel electrode 3, a utilization of 50%, a relative humidity of 50%, and a temperature of 85° C. The cell potential was defined as an electric potential. The electric potential generated by the polymer electrolyte fuel cell of the present example was 0.70 V. The results are shown in Table 1.

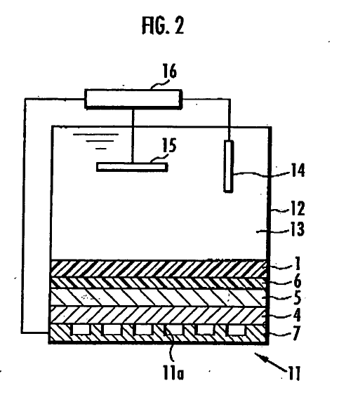

On the other hand, the Q value was measured using the apparatus shown in FIG. 2. The apparatus of FIG. 2 is configured such that an electrode 11 having a structure identical to the oxygen electrode 2 and the fuel electrode 3 of FIG. 1 was provided on only a single side of the polymer electrolyte membrane 1 and that the thus obtained product was placed in the bottom of a tank 12, so as to make the polymer electrolyte membrane 1 with the electrode 11 to come into contact with a sulfuric acid aqueous solution 13 with pH 1 that was filled in the tank 12. The apparatus of FIG. 2 comprises a reference electrode 14 and a control electrode 15 that were immersed in the sulfuric acid aqueous solution 13. Each of the reference electrode 14, the control electrode 15, and the backing layer 4 of the electrode 11 was connected to a potentiostat 16. Moreover, the electrode 11 comprises a gas passage 11a, which corresponds to an oxygen passage 2a of the oxygen electrode 2 or a fuel passage 3a of the fuel electrode 3 as shown in FIG. 1. Thus, the electrode 11 is configured such that it freely comes into contact with nitrogen gas, which is supplied through the gas passage 11a.

In the apparatus of FIG. 2, when voltage is charged to the point between the backing layer 4 and the sulfuric acid aqueous solution 13 by the potentiostat 16, protons existing in the sulfuric acid aqueous solution 13 reach the electrode 11 through the polymer electrolyte membrane 1 to receive electrons therefrom. This is to say, protons come into contact with the surface of platinum in the catalyst layer 5, so that electrons are transferred from the platinum to the protons. In the apparatus of FIG. 2, the amount of platinum in the catalyst layer 5 of the electrode 11 is 0.5 g/cm².

In contrast, when reverse voltage is charged thereto, electrons are transferred from hydrogen atoms adsorbing them to platinum, and the electrons are diffused as protons in the sulfuric acid aqueous solution.

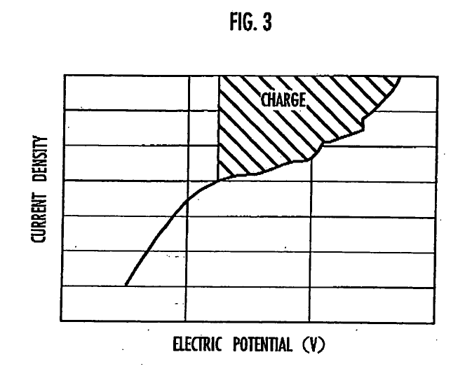

Hence, when the voltage is scanned from −0.5 V to 1 V, as shown in FIG. 3, Q value can be obtained from the peak area of the adsorption side of protons. Herein, Q value shows the amount of charge (C/cm²) per area of the electrode 11. As this value is great, it indicates high adhesiveness of the electrode to the polymer electrolyte membrane.

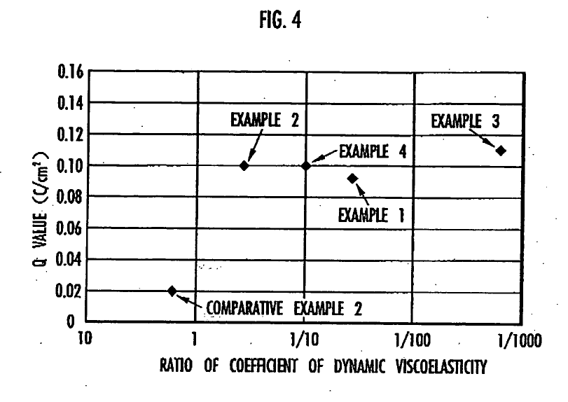

In the polymer electrolyte fuel cell in the present example, the Q value was 0.091. The relationship between the ratio of the coefficient of dynamic viscoelasticity at 110° C. between the polymer electrolyte membrane 1 and the buffer layer 6 (buffer layer 6/polymer electrolyte membrane 1; hereinafter abbreviated as a coefficient of dynamic viscoelasticity ratio), and the Q value, is shown in FIG. 4.

### EXAMPLE 2

In the present example, the polymer electrolyte fuel cell of FIG. 1 was formed completely in the same manner as in Example 1 with the exception that a sulfonated polyarylene represented by the following formula (4) was used to produce a buffer layer 6 having an ion exchange capacity of 1.9 meq/g.

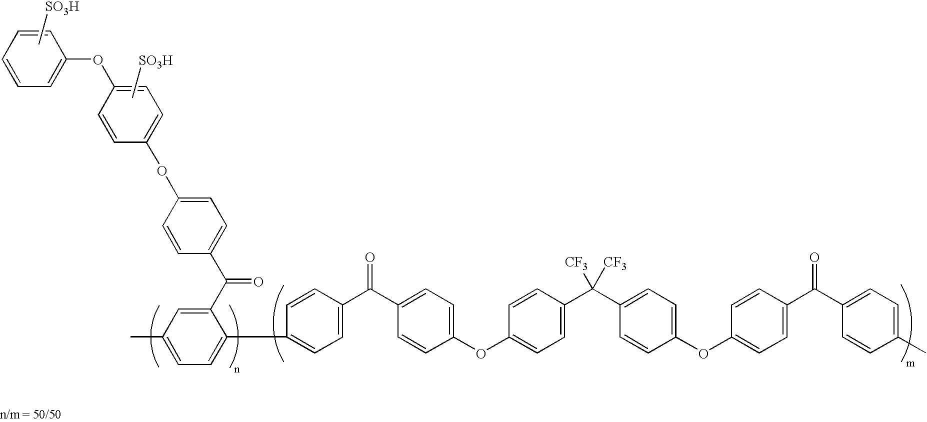

Thereafter, the coefficient of dynamic viscoelasticity at 110° C. of the buffer layer 6, and the electric potential and Q value of the polymer electrolyte fuel cell were measured completely in the same manner as in Example 1. The coefficient of dynamic viscoelasticity at 110° C. of the buffer layer 6 of the present example was 1.5×10¹⁰ Pa. Moreover, the electric potential of the polymer electrolyte fuel cell was 0.74 V, and the Q value was 0.1 in the present example. Furthermore, the polymer electrolyte membrane 1 of the present example was identical to that of Example 1, and its coefficient of dynamic viscoelasticity at 110° C. was 4×10¹⁰ Pa.

The measurement results of generated electric potential are shown in Table 1. The relationship between the coefficient of dynamic viscoelasticity ratio and the Q value is shown in FIG. 4.

### EXAMPLE 3

In the present example, the polymer electrolyte fuel cell of FIG. 1 was formed completely in the same manner as in Example 1 with the exception that a perfluoroalkylene sulfonic acid polymer (Flemion (product name) by Asahi Glass Co., Ltd.) was used to produce a buffer layer 6.

Thereafter, the coefficient of dynamic viscoelasticity at 110° C. of the buffer layer 6, and the electric potential and Q value of the polymer electrolyte fuel cell were measured completely in the same manner as in Example 1. The coefficient of dynamic viscoelasticity at 110° C. of the buffer layer 6 of the present example was 7.0×10⁷ Pa. The electric potential was 0.70 V, and the Q value was 0.11 in the present example. Furthermore, the polymer electrolyte membrane 1 of the present example was identical to that of Example 1, and its coefficient of dynamic viscoelasticity at 110° C. was 4×10¹⁰ Pa.

The measurement results of generated electric potential are shown in Table 1. The relationship between the coefficient of dynamic viscoelasticity ratio and the Q value is shown in FIG. 4.

### EXAMPLE 4

In the present example, the polymer electrolyte fuel cell of FIG. 1 was formed completely in the same manner as in Example 1 with the exception that the sulfonated polyarylene represented by the formula (4) was used to produce a polymer electrolyte membrane 1 having an ion exchange capacity of 1.9 meq/g.

Thereafter, the electric potential and Q value of the polymer electrolyte fuel cell were measured completely in the same manner as in Example 1. The electric potential and Q value of the polymer electrolyte fuel cell of the present example were 0.76 V and 0.1, respectively. Furthermore, the polymer electrolyte membrane 1 of the present example was identical to the buffer layer 6 of Example 2, and its coefficient of dynamic viscoelasticity at 110° C. was 1.5×10¹⁰ Pa. Still further, the buffer layer 6 of the present example was identical to that of Example 1, and its coefficient of dynamic viscoelasticity at 110° C. was 1.5×10⁹ Pa.

The measurement results of generated electric potential are shown in Table 1. The relationship between the coefficient of dynamic viscoelasticity ratio and the Q value is shown in FIG. 4.

### COMPARATIVE EXAMPLE 1

In the present comparative example, the polymer electrolyte fuel cell of FIG. 1 was formed completely in the same manner as in Example 1 with the exception that a buffer layer 6 was not provided.

Thereafter, the electric potential and Q value of the polymer electrolyte fuel cell were measured completely in the same manner as in Example 1.

The electric potential and Q value of the polymer electrolyte fuel cell of the present comparative example were 0.62 V and 0.06, respectively. Furthermore, the polymer electrolyte membrane 1 of the present comparative example was identical to that of Example 1, and its coefficient of dynamic viscoelasticity at 110° C. was 4×10¹ Pa.

The measurement results of generated electric potential are shown in Table 1. Since the buffer layer 6 was not provided in the present comparative example, its coefficient of dynamic viscoelasticity ratio could not be calculated.

### COMPARATIVE EXAMPLE 2

In the present comparative example, the polymer electrolyte fuel cell of FIG. 1 was formed completely in the same manner as in Example 1 with the exception that a buffer layer 6 having an ion exchange capacity of 1.5 meq/g was produced using the sulfonated polyarylene represented by the formula (3).

Thereafter, the coefficient of dynamic viscoelasticity at 110° C. of the buffer layer 6, and the electric potential and Q value of the polymer electrolyte fuel cell were measured completely in the same manner as in Example 1. The coefficient of dynamic viscoelasticity at 110° C. of the buffer layer 6 of the present comparative example was 6.5×10¹⁰ Pa. The electric potential and Q value of the polymer electrolyte fuel cell of the present comparative example were 0.58 V and 0.02, respectively. Furthermore, the polymer electrolyte membrane 1 of the present comparative example was identical to that of Example 1, and its coefficient of dynamic viscoelasticity at 110° C. was 4×10¹⁰ Pa. Thus, the coefficient of dynamic viscoelasticity at 110° C. of the buffer layer 6 was greater than that of the polymer electrolyte membrane 1.

The measurement results of generated electric potential are shown in Table 1. The relationship between the coefficient of dynamic viscoelasticity ratio and the Q value is shown in FIG. 4.

TABLE 1

| | Electric potential |
|---|---|
| | (V) |
| Example 1 | 0.70 |
| Example 2 | 0.74 |
| Example 3 | 0.70 |
| Example 4 | 0.76 |
| Comparative example 1 | 0.62 |
| Comparative example 2 | 0.58 |

In each of the polymer electrolyte fuel cells of Examples 1 to 4, the coefficient of dynamic viscoelasticity at 110° C. of the buffer layer 6 was smaller than that of the polymer electrolyte membrane 1, but was greater than that of the ion-conductive polymer binder in the catalyst layer 5. On the other hand, in the polymer electrolyte fuel cell of Comparative example 2, the coefficient of dynamic viscoelasticity at 110° C. of the buffer layer 6 was greater than that of the polymer electrolyte membrane 1. FIG. 4 clearly shows that each of the polymer electrolyte fuel cells of Examples 1 to 4 had a Q value greater than that of Comparative example 2, having an excellent adhesiveness of the polymer electrolyte membrane 1 to the oxygen electrode 2 and fuel electrode 3.

Moreover, Table 1 clearly shows that each of the polymer electrolyte fuel cells of Examples 1 to 4, which had an excellent adhesiveness of the polymer electrolyte membrane 1 to the oxygen electrode 2 and the fuel electrode 3 as described above, could generate an electric potential greater than that of Comparative example 1, which did not have a buffer layer 6, and than that of Comparative example 2, in which the coefficient of dynamic viscoelasticity at 110° C. of the buffer layer 6 was greater than that of the polymer electrolyte membrane 1.

In the present embodiment, the buffer layer 6 is provided both in the oxygen electrode 2 and the fuel electrode 3. However, it may be provided either one of them.

### INDUSTRIAL APPLICABILITY

The present invention can be used as a polymer electrolyte fuel cell, which is mounted on vehicles and the like.

1. A polymer electrolyte fuel cell, comprising a pair of electrodes both having a catalyst layer, where catalyst particles consisting of a catalyst carrier and a catalyst supported by said catalyst carrier are integrated by an ion-conductive polymer binder, and a polymer electrolyte membrane sandwiched between the electrodes on their sides having said catalyst layer;
characterized in that the polymer electrolyte membrane has a coefficient of dynamic viscoelasticity at 110° C. in a range of 1×10⁹ to 1×10¹¹ Pa, and the ion-conductive polymer binder forming the catalyst layer has a coefficient of dynamic viscoelasticity at 110° C. smaller than that of said polymer electrolyte membrane, and that an additional buffer layer, comprising an ion-conductive polymer material having a coefficient of dynamic viscoelasticity at 110° C. smaller than that of said polymer electrolyte membrane but greater than that of said ion-conductive polymer binder of said catalyst layer is provided between said polymer electrolyte membrane and the catalyst layer of at least either one of the electrodes.

2. The polymer electrolyte fuel cell according to claim 1, characterized in that said ion-conductive polymer binder consists of a perfluoroalkylene sulfonic acid polymer.

3. The polymer electrolyte fuel cell according to claim 1 or 2, characterized in that said polymer electrolyte membrane comprises a sulfonated polyarylene that is a copolymer consisting of 30 to 95 mol % of an aromatic compound unit represented by the following formula (1) and 70 to 5 mol % of an aromatic compound unit represented by the following formula (2) and having sulfonic acid side-chain groups: 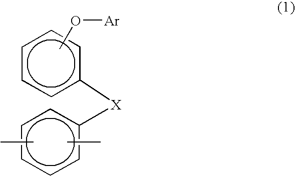
wherein Ar represents an aryl group, and X represents a divalent electron-attracting group selected from a group consisting of —CO—, —CONH—, —(CF₂)ₚ— (wherein p is an integer of 1 to 10), —C(CF₃)—, —COO—, —SO— and —SO₂—; and 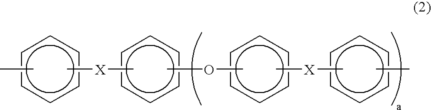
wherein X has the same meaning as that in formula (1), each of X may be identical or different, and a is an integer of 0 to 3.

4. The polymer electrolyte fuel cell according to claim 3, characterized in that said polymer electrolyte membrane comprises a sulfonated polyarylene represented by the following formula (3):

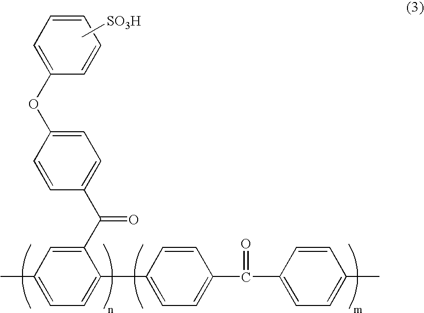

5. The polymer electrolyte fuel cell according to any one of claims 1 to 4, characterized in that the ion-conductive material constituting said buffer layer comprises a sulfonated polyarylene that is a copolymer consisting of 50 to 70 mol % of an aromatic compound unit represented by the following formula (1) and 50 to 30 mol % of an aromatic compound unit represented by the following formula (2) and having side-chain sulfonic acid groups: 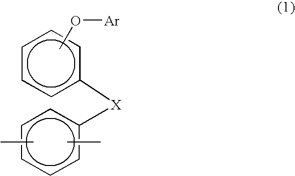
wherein Ar represents an aryl group, and X represents a divalent electron-attracting group selected from a group consisting of —CO—, —CONH—, —(CF₂)ₚ— (wherein p is an integer of 1 to 10), —C(CF₃)—, —COO—, —SO— and —SO₂—; and 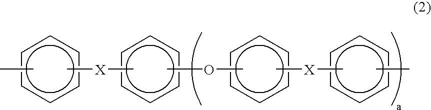
wherein X has the same meaning as that in formula (1), each of X may be identical or different, and a is an integer of 0 to 3.

6. The polymer electrolyte fuel cell according to claim 5, characterized in that the ion-conductive material constituting said buffer layer comprises a sulfonated polyarylene represented by the following formula (4):

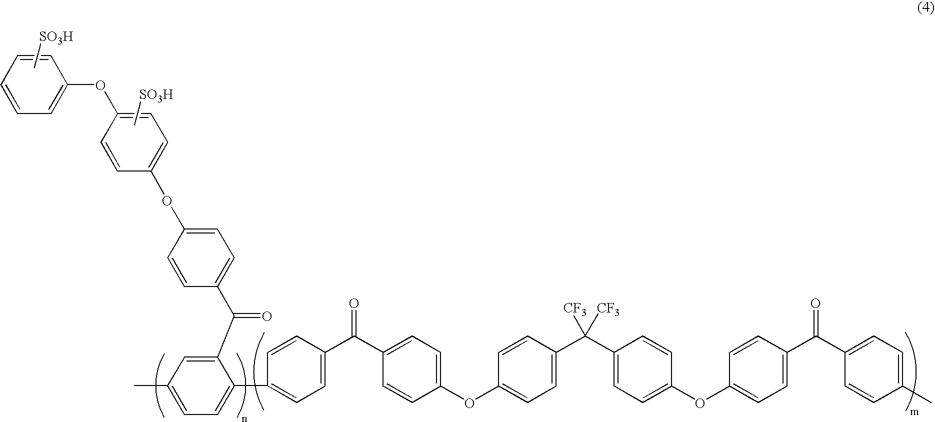

7. The polymer electrolyte fuel cell according to any one of claims 1 to 4, characterized in that the ion-conductive material constituting said buffer layer comprises a sulfonated polyether ether ketone represented by the following formula (5):

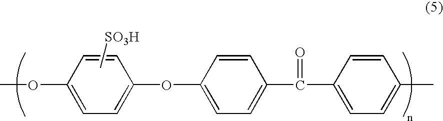

8. The polymer electrolyte fuel cell according to any one of claims 1 to 4, characterized in that the ion-conductive material constituting said buffer layer comprises a perfluoroalkylene sulfonic acid polymer.

9. The polymer electrolyte fuel cell according to any one of claims 1 to 8, characterized in that the ion-conductive material constituting said buffer layer has a coefficient of dynamic viscoelasticity at 110° C. within a range from ½ to 1/1000 of that of said polymer electrolyte membrane.
